(19) United States
(12) Patent Application Publication
(10) Pub. No.: US 2005/0109168 A1
(43) Pub. Date: May 26, 2005

(54) Self-tightening adjustable wrench

(76) Inventor: Luke W. Clauson, Menlo Park, CA (US)

Correspondence Address: HOEKENDIJK & LYNCH, LLP, P.O. BOX 4787, BURLINGAME, CA, 94011-4787, US

(21) Appl. No.: 10/966,151

(22) Filed: Oct. 15, 2004

Related U.S. Application Data
(60) Provisional application No. 60/512,575, filed on Oct. 16, 2003.

(51) Int. Cl. B25B 13/46

(52) U.S. Cl. 81/165

(57) ABSTRACT

A hand manipulated wrench is provided which includes a handle assembly which transmits part of the force applied to the handle to close the jaws. After the force on the handle has been released, the closing force will also be released. The wrench may be designed to close only when the jaws are rotated in a particular direction or may be designed to close when the wrench is rotated in either direction.

### CROSS-REFERENCE TO RELATED APPLICATIONS

This application claims the benefit of Provisional Application No. 60/512575, filed on Oct. 16, 2003.

### BACKGROUND OF THE INVENTION

1. Field of invention

This invention relates to wrenches that self-tighten or adjust during use.

2. Background of the Invention

Many mechanical devices have been used to apply torque to fastening elements such as nuts and bolts. Examples include, box end wrenches, sockets, self-locking plies such as Vice Grips™, and adjustable wrenches such as the Crescent™ wrench. The adjustable wrench is one of the most versatile implements for applying torque to nuts and bolts available. They at times fail to sufficiently grab the desired mechanical device, such as a hexagonal nut. This often leads to damage such as rolled edges. Once a nut or bolt jaw is damaged it may be extremely difficult to apply torque to the damaged hex or square.

Another problem with conventional wrenches is that they must be adjusted relatively precisely to provide a tight fit between the wrench and nut to prevent damaging the nut. This process is generally performed by wiggling the wrench with the user then manipulating the screw with the thumb to tighten the wrench. Oftentimes, the wrench is tightened to such a degree that the user must open the jaws by rotating the thumb adjustor in the opposite direction. If the wrench is then going to be used on another nut of the same size, the wrench must again be wiggled and adjusted even though the wrench had just been used on the same size nut.

### SUMMARY

The present invention provides a hand manipulated wrench which includes a mechanism to close the jaws or apply additional closing force to the jaws when force is applied to the handle. The wrench includes a handle assembly, which includes the handle, which transmits part of the force exerted by the user on the handle to torque the work object into a force which closes the jaws.

The hand manipulated wrench has two jaws mounted to a body with at least one of the jaws being movable relative to the other jaw. The handle assembly has a handle which pivots relative to the body. An adjustor is used to adjust the distance between the first and second jaws. A force transmitting assembly transmits a closing force to at least one of the jaws to force the jaws toward one another when force is applied to the handle by the user. The closing force may be released when user stops exerting force on the handle. A spring exerts a force to separate the first and second jaws when the force on the handle is released by the user. The handle assembly may apply the closing force to the jaws only when the handle is rotated in one direction or may apply the closing force when the handle is rotated in either direction.

The present invention reduces the need for numerous fine adjustments to a hand held wrench as is normally required particularly when working on a number of work objects of the same size or when the same work object must be released and re-engaged a number of times.

### BRIEF DESCRIPTION OF THE DRAWINGS

FIG. 1A-C show a double wedge operated 90 degree self-tightening wrench.

FIG. 2A-C show a cam operated self tightening 90 degree wrench.

FIG. 3A-C shows a single wedge 67.5 degree self-tightening wrench.

FIG. 4A-C shows an off-centered sliding pin 67.5 degree self-tightening wrench.

FIG. 5A-D shows a centered sliding pin 67.5 degree self-tightening wrench. PATENT

FIG. 6A-D shows a camming centered sliding pin 67.5 degree self-tightening wrench.

FIG. 7A-D shows a left hung centered lever 67.5 degree self-tightening wrench.

FIG. 8A-C shows a left hung offset lever 67.5 degree self-tightening wrench.

FIG. 9A-D shows a right hung lever 67.5 degree self-tightening wrench.

FIG. 10A-B shows a 67.5 degree ratcheting wedge self-tightening wrench.

FIG. 11A-C shows a 67.5 degree push pin self-tightening wrench.

FIG. 12A-C shows a 67.5 degree push lever self-tightening wrench.

FIG. 13A-D shows a 67.5 degree cammed adjustor pin self-tightening wrench.

### DETAILED DESCRIPTION OF THE PREFERED EMBODIMENTS

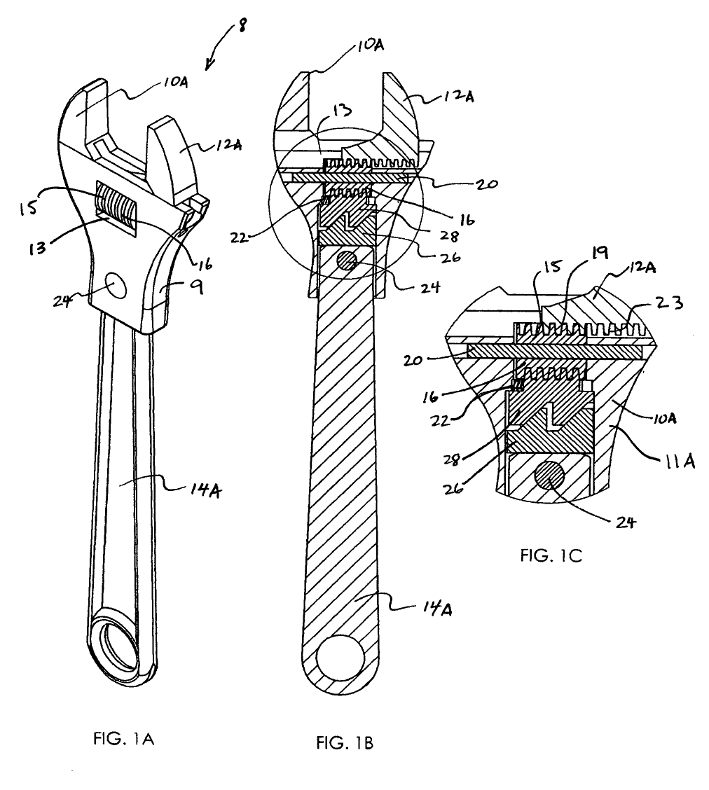

FIGS. 1A-1C show a wrench 8 having a first wrench jaw 10A, a second wrench jaw 12A and a handle 14. The handle 14A is pinned by a handle pin 24 to the fixed wrench jaw 10A. The handle 10A is constrained within a body 9 in all directions but is allowed to rotate or pivot about the axis of the handle pin 24. The handle 14A can rotate as much as the body 9 of the fixed wrench jaw 10A, into which the handle 14A is inserted, allows. Hard stop features are provided for in each embodiment, generally between the handle 14A and fixed wrench jaw 10A, to limit how far the handle swings when actuated. The handle 10A is part of a handle assembly 11 which transmits part of the force exerted by the user on the handle 10A into forcing the second jaw 12A toward the first jaw 10A.

The wrench 8 may have features similar to a conventional wrench for ease of use and acceptance. Of course, the wrenches described herein may have other mechanisms without departing from the scope of the numerous aspects of the present invention. The sliding wrench jaw 12A is adjusted by rotating an adjustor 16 which is supported in a pocket 13 of the fixed wrench jaw 10A and is rotatably mounted on an adjustor pin 20. The adjustor 16 is in the form of a gear 15 having a surface 17 formed by teeth 19 on the bottom of the second movable jaw 12A. The first jaw 10A has a complementary engaging surface 21 such as teeth 23. The adjustor permits the wrench to be continuously adjusted to any size within a defined range. The adjustor 16 is exposed through a window 23 in the body 9.

The wrench 8 has the ability to automatically decrease the space between the fixed wrench jaw 10A and the sliding wrench jaw 12A. Decreasing this space, after the adjustor 16 has been finger tightened to the correct size, further tightens the wrench 8 to provide a more secure grip as force is applied to the handle 14A.

The wrench is generally used in the same manner as a conventional adjustable wrench. The wrench jaw is adjusted to the correct size (i.e., of the bolt to be tightened) by rotating an adjustment mechanism, then force applied to the handle to apply torque.

The following descriptions apply to the various methods and mechanisms contemplated to decrease the space between the fixed and sliding wrench jaws. As a rule, return spring(s) 22 are provided in the designs to return the handle 14A to a centered position and provide the user with a semi-rigid tool until significant force is applied to the handle.

The handle assembly 11 operates to drive the second jaw 12A in the following manner. The top of the handle 14A, pivoting about the handle pin 24, bears on a bottom wedge 26, which acts as a camming element, to drive it upwards. As it is driven upwards it drives the top wedge 28 to the left as oriented in the Figures. As the top double wedge 28 is driven to the left it drives the adjustor 16 to the left, which tightens the wrench. Moving the wrench handle 14A in either direction moves the sliding wrench jaw 12A in the direction described above, thus, the wrench tightens around the bolt when the wrench 8 is rotated in either direction.

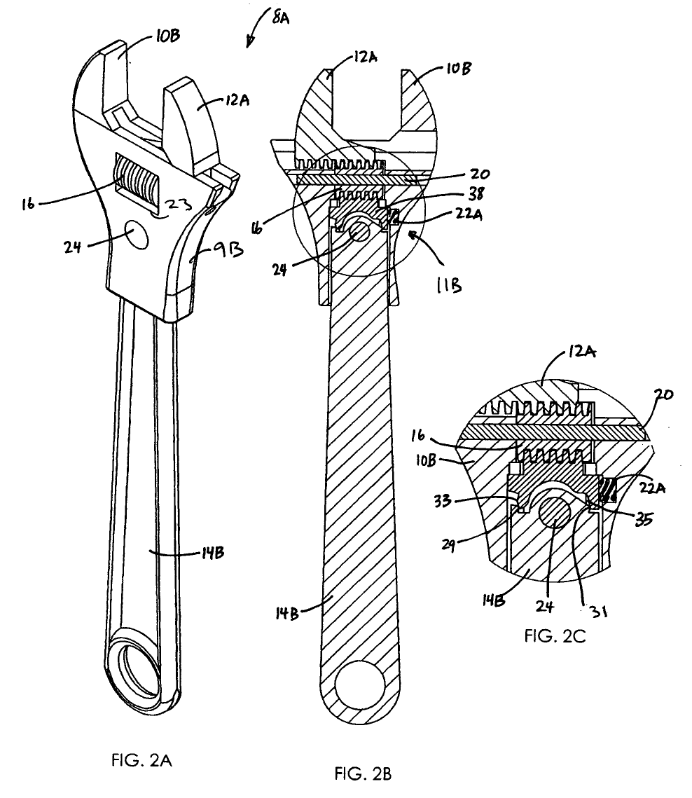

FIGS. 2A-C show another wrench 8A which has a tightening mechanism which is cam actuated wherein the same or similar numbers refer to the same or similar structure. A handle assembly 11A is used to drive the second jaw as now described. The handle assembly 11A includes a handle 14 which has two cam surfaces 29, 31. The handle 14 is partially housed and pivots relative to body 9A. Each cam surface 29, 31 interacts with a cam tightener 38 that has two mating cam surfaces 33, 35. As force is applied to the wrench handle 14 one of the two cam surfaces interact to drive the cam tightener 18 to the right as oriented in the Figures. Teeth 37 on the cam tightener 38 move the adjustor 16 to the right, thus tightening the wrench 8A. If force is applied to the handle 14 in the other direction the other cam surface pair interact to close the gap between the jaws and to tighten the wrench 8A around the nut.

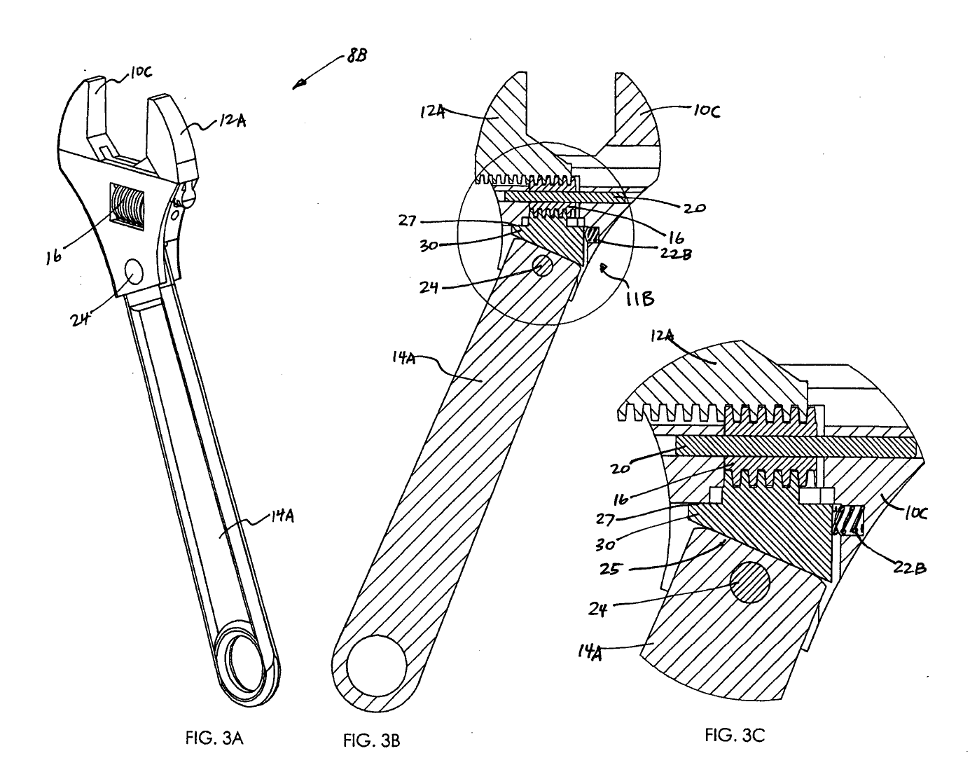

FIGS. 3A-C show still another wrench 8B which has yet another handle assembly 11B which is used to transmit part of the force exerted on the handle 14 to close the jaws. The top of the handle 14B bears on the bottom of a wedge 30. As force is applied to the handle 14 it pivots about the handle pin 24 and a top surface 25 drives the wedge 30 upward. A top 27 of the wedge 30 is supported by the first jaw 10C which may be an angle other than 90 degrees with respect to the handle 14 length centerline. As the wedge 30 moves upward it also slides to the right, thus moving the adjustor 16 and the second jaw 12. This tightens the wrench 8B in the same direction regardless of the direction of the force applied to the handle 14.

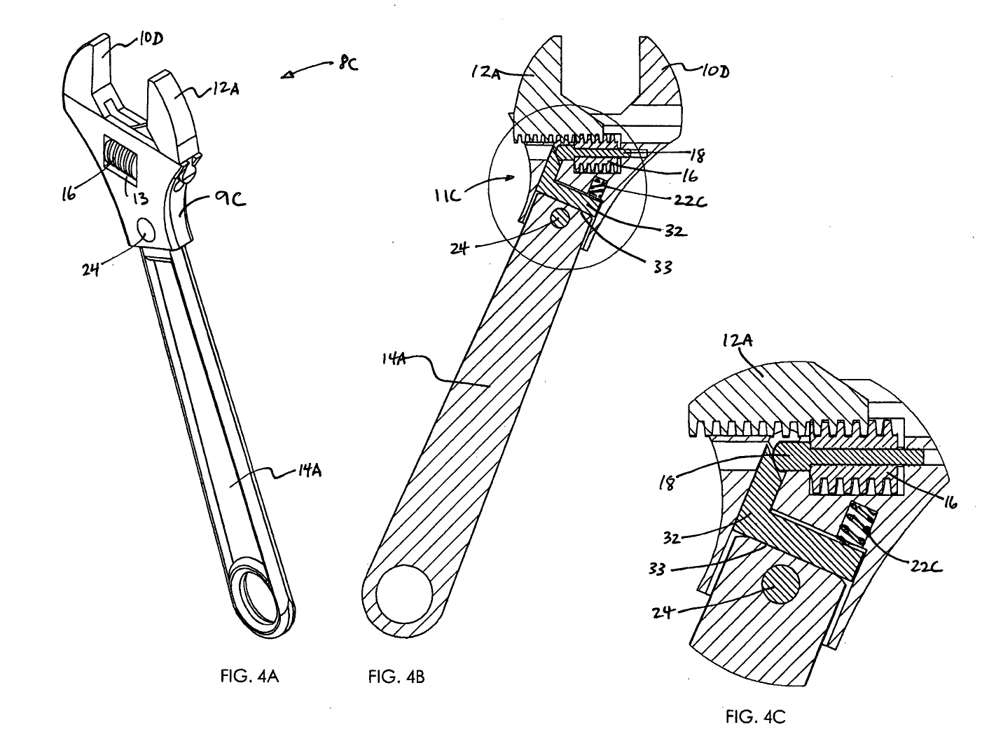

FIGS. 4A-C shows still another wrench 8C which includes a handle assembly 11C which has an off-center sliding pin 32. The off-center sliding pin 32 is constrained so that it can only move along a single axis in the fixed wrench jaw 10C. As force, in either direction, is applied to the wrench handle 14C its top surface 33 drives the off-center sliding pin 32 upward, pushing the bearing adjustor pin 18 to the right. The bearing adjustor pin 18 moves the adjustor 16C and consequently, the second jaw 12C to the right thereby closing the space between the jaws 10C, 12C and tightening the wrench 8C around the nut or other object being manipulated.

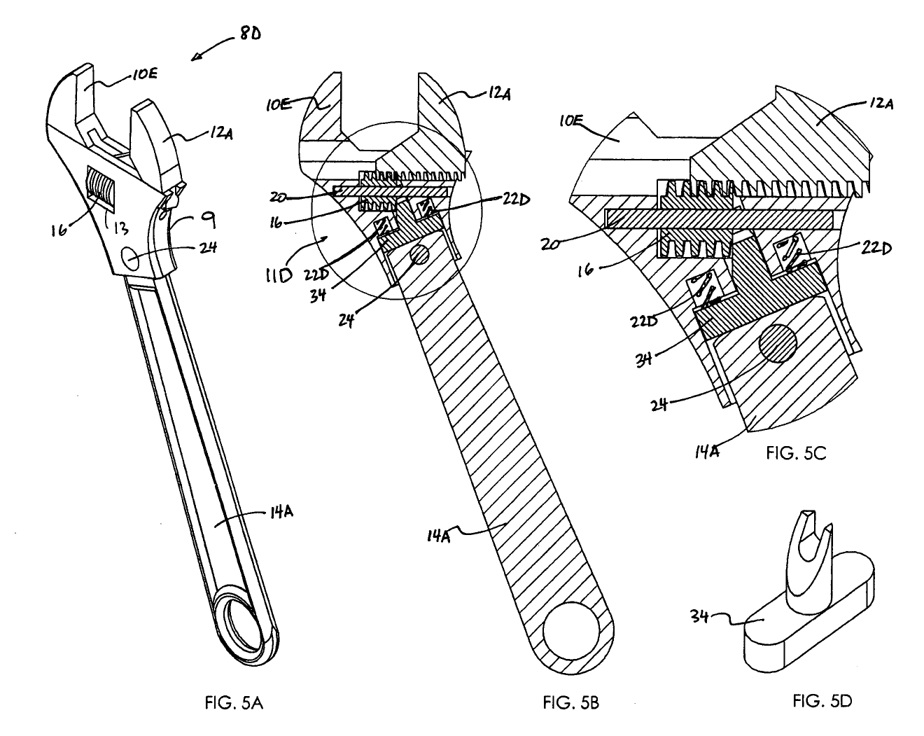

FIGS. 5A-D show yet another wrench 8D having a handle assembly 11D with a centered sliding pin 34 wherein the same or similar reference numbers refer to the same or similar structures. The centered sliding pin 34 is constrained such that it can only move along a single axis in the fixed wrench jaw 10E. As force, in either direction, is applied to the wrench handle 14 its top surface 35 drives the center sliding pin 34 upward, pushing adjustor 16 to the left. The adjustor 16 moves the second jaw 12 toward the first jaw 10D thereby closing the distance between the jaws 10E, 12 and tightening the wrench 8D.

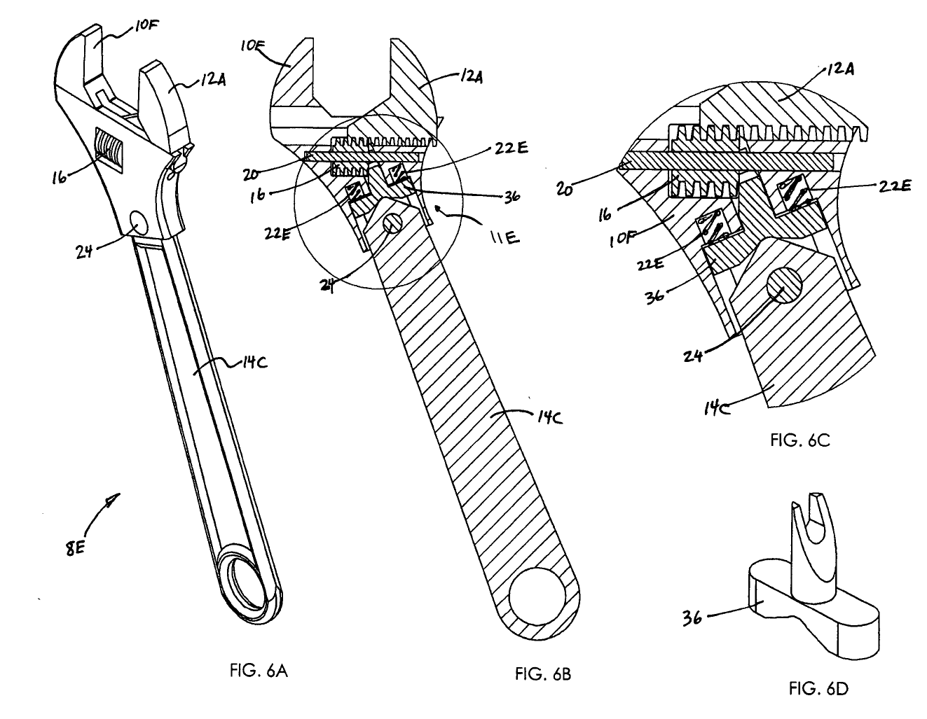

FIGS. 6A-D show another wrench 8E having still another handle assembly 11E with a camming centered sliding pin 36. The camming centered sliding pin 36 is constrained such that it can only move along a single axis in the first wrench jaw 10E. As force, in either direction, is applied to the wrench handle 14 a top lobe 38 drives the camming center sliding pin 34. This motion pushes the adjustor 16 to the left which also pushes the second jaw 12 to the left thereby tightening the wrench 8E.

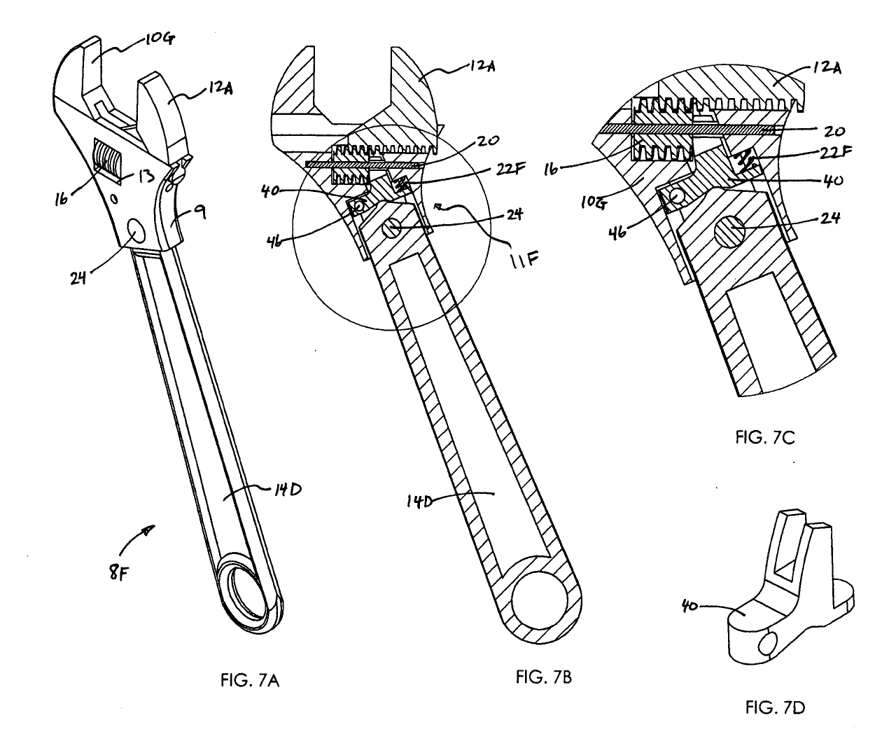

FIGS. 7A-D show another wrench 8F with a handle assembly 11F using a left hung centered lever 40 wherein the same or similar reference numbers refer to the same or similar structure. The left hung centered lever 40 pivots about a lever pivot pin 46. As force in either direction is applied to the handle 14 the top lobe on the handle 14 drives the left hung centered lever 40 upwards which simultaneously rotates it to the left. This rotation moves the adjustor 16 and in turn slides the second jaw 12F to tighten the wrench 8F.

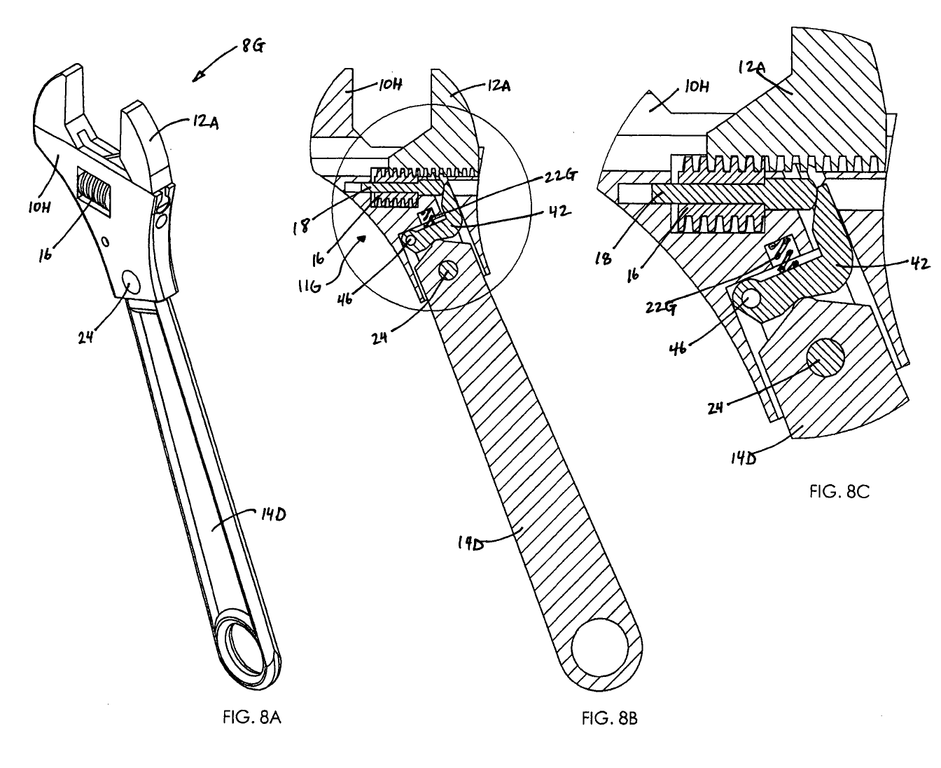

FIGS. 8A-C show another wrench 8G with a handle assembly 11G using a left hung offset lever 42 wherein the same or similar reference numbers refer the same or similar structure. Wrench 8G is similar to the wrench of FIGS. 7A-D but unlike the wrench of FIGS. 7A-D, which has an actuation device that bears directly on the adjustor 16, the wrench 8G has the left hung offset lever 42 which directly drive the bearing adjustor pin 18 to the left. This bearing adjustor pin 18 pushes on the adjustor 16, which pushes on the second jaw 12 to tighten the wrench 8G. Lastly, though a lever pivot pin 46 may be included, it is possible to omit this pin 46 and allow the left hung offset lever 42 to pivot on the contact surfaces inside the first jaw 10. Any unwanted side to side motion of the left hung offset lever 42 would be constrained by its width, which would contact the sides of the pocket in the fixed wrench jaw 12.

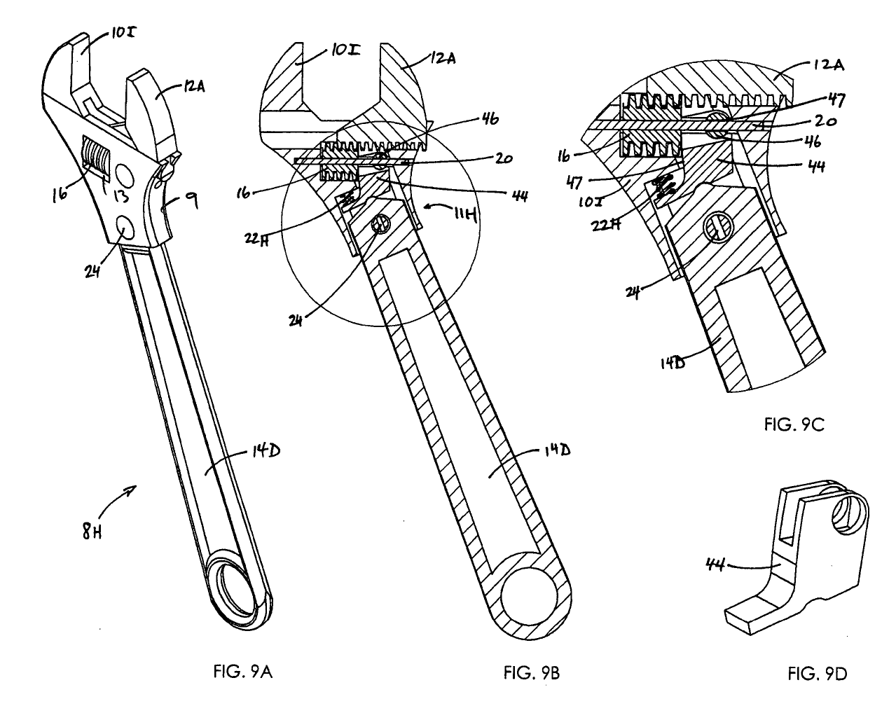

FIGS. 9A-C show still another wrench 8H having a handle assembly 11H which uses the force applied to a handle 14D to drive the jaws toward one another. The handle assembly 11H includes a right hung lever 44 which pivots about a lever pivot pin 46. The lever pivot pin 46 has a hole 47 to allow the adjustor pin 20 to pass through it. As force in either direction is applied to the handle 14D a top lobe 45 on the handle 14D drives the right hung lever 44 upwards which simultaneously pushes the adjustor 16H to the left by means of a sloped ramp 47 on the right hung lever 44. The adjustor 16 is coupled to the second jaw 12A so that when the adjustor moves the second jaw slides toward the first jaw 10I to tighten the wrench 8H.

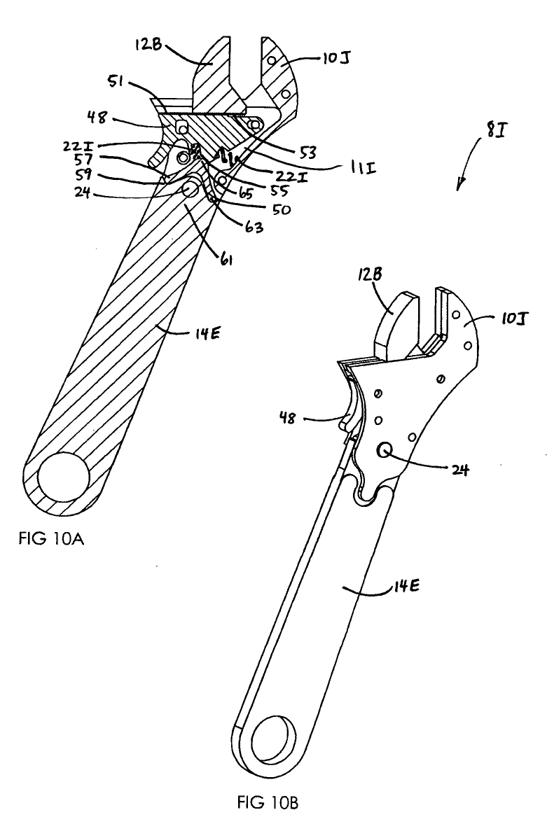

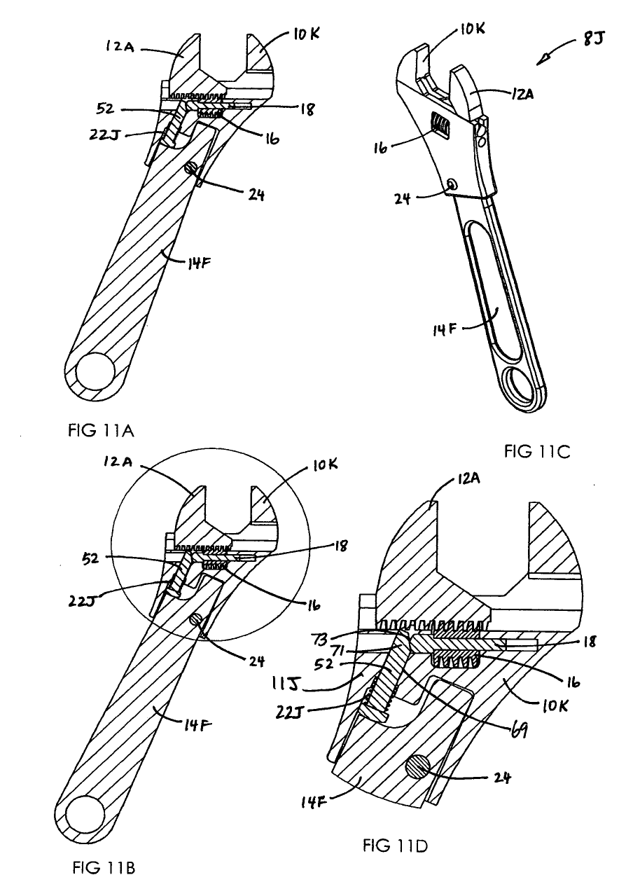

FIGS. 10A-B show still another wrench 8I having a handle assembly 11I with a ratcheting wedge 48 self-tightening wrench. The adjustor commonly employed in the other embodiments is replaced with the wedge 48. A toothed side 51 of the wedge 48 engages corresponding teeth 53 on a second jaw 12B. A bottom side 55 of the wedge 48 engages a triangularly shaped cam 50. The cam 50 has a corner 57 bearing on a side 59 of a top part 61 of the handle 14E. Another side 63 of the cam 50 bears on the other side of the top part 61 of the handle 14E. A top edge 65 of the cam 50 bears on a bottom side 55 of the ratcheting wedge 48.

When force is applied to the handle 14 in either direction, the handle 14 pivots around its handle pin 24 driving one side of the top part 61 of the handle 14 upwards. This drives the ratcheting wedge 48, moving the sliding wrench jaw 12B toward the fixed wrench jaw 10J thereby closing the first and second jaws 10J, 12B onto the object being turned. When the handle 14 is rotated the other direction, the other side of the cam 50 is engaged to create the same tightening affect between the jaws 10J, 12B. Lastly, to adjust this wrench 8I the ratcheting wedge 48 is pulled downward toward the handle 14 thus releasing the engagement between the teeth 51, 53 from the sliding wrench jaw 12. With the wedge 48 held downward, the wrench 81 can be adjusted by moving the sliding wrench jaw 12 to the appropriate location. At least one return spring 22I moves the ratcheting wedge 48 back into engagement with the sliding wrench jaw 12B once adjusted.

FIGS. 11A-C show still another wrench 8J having a handle assembly 11J is shown which uses a push pin 52. One side of the distal end of the handle 14I bears on the push pin 52. The push pin 52 slides in a bore 69 in the first jaw 10K. A jaw 71 of the push pin 52 has a ramp 73 which bears on a bearing adjustor pin 18. A return spring 22 pushes the push pin 52 away from the bearing adjustor pin 18 and biases the handle 14F to one side. When force is applied to the handle 14F in the direction of the second jaw 12A the push pin 52 is driven upwards, driving the bearing adjustor pin 18 and correspondingly, adjustor 16 and sliding wrench jaw 12A thereby automatically tightening the wrench when the wrench is torqued.

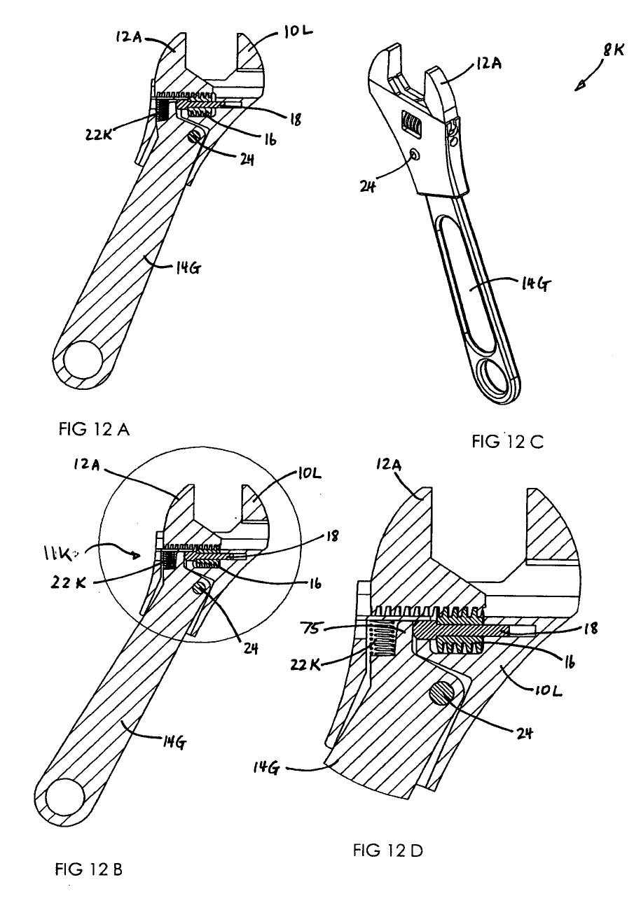

FIGS. 12A-C show yet another wrench 8K is shown where the same or similar reference numbers refer to the same or similar structure Handle assembly 11K includes a handle 14G having a boss 75 distal to a handle pin 24 which bears on a bearing adjustor pin 18G. As force is applied to the handle 14G in the direction of the sliding wrench jaw 12 the handle 14G slightly rotates about the handle pin 24. This rotation causes the boss 75 on the distal end of the handle 14G to drive the bearing adjustor pin 18, adjustor 16 and second jaw 12 toward the first jaw 10L so that the wrench 8K automatically clamps down on the object being turned.

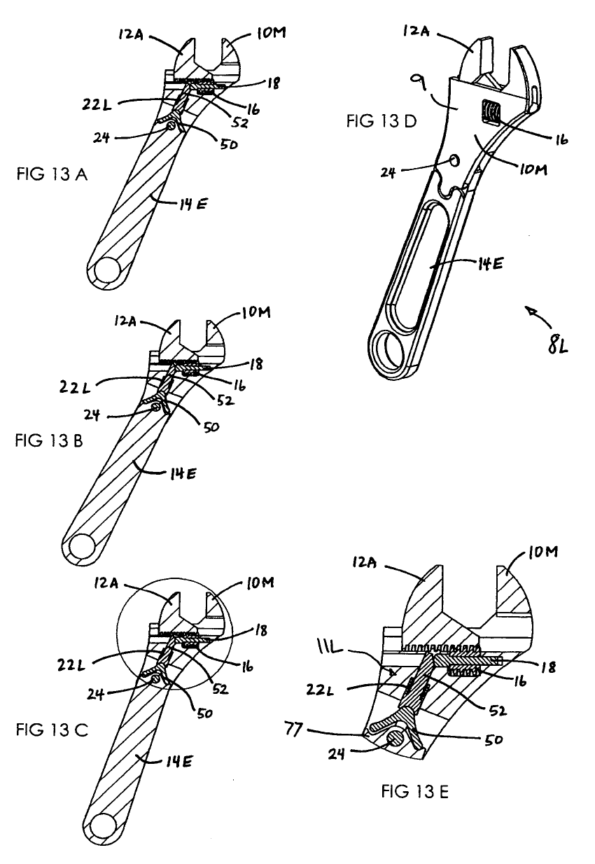

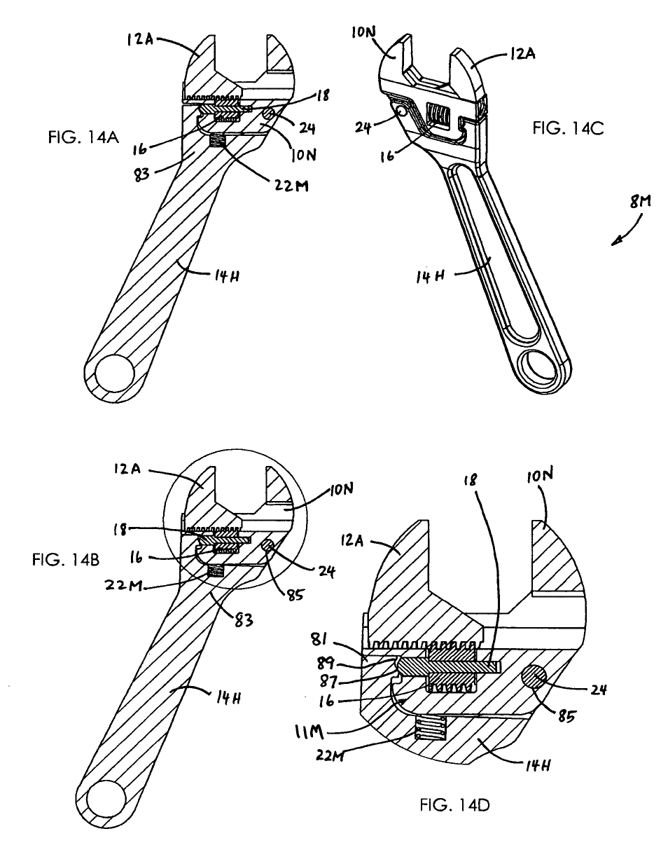

FIGS. 13A-D show another wrench 8L having a handle assembly 11L where the same or similar reference numbers refer to the same or similar structure. The basic mechanism that provides motion to tighten the sliding wrench jaw 12A in this embodiment is similar to that described in FIGS. 10A-B. The handle 14E rotates about handle pin 24 driving a side 77 of the distal end of the handle 14E and in turn the cam 50 upward. The side 77 which is driven upward depends on the direction the handle 14K is pulled. The cam 50 pushes upward on a push pin 52K which drives a bearing adjustor pin 18, adjustor 16 and the second jaw 12A toward the first jaw 10M thereby tightening the wrench

FIGS. 14A-C show still another wrench 8M where the same or similar reference numbers refer to the same or similar structure. A handle assembly 11M includes a handle 14H having a boss 81 on a side of a distal portion 83 and a handle pin hole 85 on the other side of its distal end. The handle pin 24 provides a pivoting connection between the handle 14 and the first jaw 10N. The boss 81 opposite the handle pin hole 85 has at least one ramp surface 87 which bears on bearing adjustor pin 18. As force is applied to the handle 14H in the direction of the second jaw 12A the ramp 87 on the distal end of the handle 14H slides with respect to the bearing adjustor pin 18, driving it and the adjustor 16 toward the handle pin 24. Thus, the second jaw 12M is driven closed with respect to the first jaw 10N. If the tightening effect is desired in both directions of pull for the wrench 8M, another ramp 89 directly above the previously discussed ramp is included, as shown in FIGS. 14A-B. As such, when the handle 14H is pulled away from the second jaw 12A the second ramp 89 drives the bearing adjustor pin 18, adjustor 16 and second wrench jaw 12A to tighten the wrench 8M. In both configurations, at least one return spring 22 insures a neutral bias before force is applied to the handle 14H. Features are provided between the handle 14H and the first jaw 10N to limit the extent to which the handle 14M can pivot about the handle pin 24. Examples of such stop features are included on the boss at the distal end of the handle 14H in FIGS. 14A-C.

The wrenches and components included in this invention can be manufactured by one or a combination of the following processes: casting, machining, electric discharge machining, powdered metal processes, laser cutting, forging, water jet cutting, grinding, metal injection molding and other common processes. The wrench and components would most likely be made of steel and other tough metals.

The present invention has been described in connection with various preferred embodiments but it is understood that other embodiments are possible without departing from the scope of the invention.

1. A hand manipulated wrench used for manipulating a rotating element, comprising:
a body;
a first jaw mounted to the body;
a second jaw mounted to the body, the second jaw being movable relative to the first jaw;
a handle assembly having a handle pivotally mounted to the body;
an adjustor coupled to the body, the adjustor being manually manipulability to adjust the distance between the first and second jaws; and
a force transmitting assembly coupled to the body, the force transmitting assembly transmitting a closing force to the second jaw which forces the second jaw toward the first jaw when a force is applied to the handle by the user.

2. The hand manipulated wrench of claim 1, wherein:
the force transmitting assembly releases the closing force applied to the first jaw when the force applied to the handle by the user is removed.

3. The hand manipulated wrench of claim 1, further comprising:
a spring which exerts a forces to separate the first and second jaws when the force on the handle is released by the user.

4. The hand manipulated wrench of claim 1, wherein:
the first jaw is fixed relative to body so that the handle pivots relative to the first jaw.

5. The hand manipulated wrench of claim 1, wherein:
the force transmitting assembly applies the closing force to the first jaw when the user exerts the force to the handle in either direction.

6. The hand manipulated wrench of claim 1, wherein:
the force transmitting assembly applies the closing force to the second jaw when the force is applied to the handle in one direction but not the other.

7. The hand manipulated wrench of claim 1, wherein:
the second jaw is linearly slidable on the body so that the orientation between the first and second jaws remains the same when changing the distance between the first and second jaws.

8. The hand manipulated wrench of claim 1, wherein:
the adjustor provides a continuously variable distance between the first and second jaws.

9. The hand manipulated wrench of claim 1 wherein:
the adjustor includes a rotating element mounted to the body, the rotating element being manually rotatable by the user to adjust the distance between the first and second jaws.

10. The hand manipulated wrench of claim 1 wherein:
the rotating element is exposed through a window in body.

11. The hand manipulated wrench of claim 1 wherein:
the rotating element is rotatably mounted to the body and rotates on a pin mounted to the body.

12. The hand manipulated wrench of claim 1 wherein:
the force transmitting assembly engages the pin to apply the closing force to the second jaw.

13. The hand manipulated wrench of claim 1 wherein:
the handle assembly engages the rotating element to apply the closing force to the second jaw.

14. The hand manipulated wrench of claim 1 wherein the handle assembly engages a force transmitting member at two different locations depending upon the direction of rotation applied by the user to the handle.

15. The hand manipulated wrench of claim 1 wherein the distance between the jaws is adjusted using a rotating element mounted to the body.

16. The hand manipulated wrench of claim 1 wherein the handle assembly engages the pin to force the second jaw toward the first jaw.

17. The hand manipulated wrench of claim 1 wherein the handle assembly engages the rotating element to force the second jaw toward the first jaw.

18. The hand manipulated wrench of claim 1, wherein:
the handle assembly includes a cam element which engages the handle and the pin, wherein the force applied to the handle is transmitted through the cam element and to the pin to apply the closing force to the second jaw.

19. The hand manipulated wrench of claim 18, wherein:
the cam element is rotatably coupled to the body.

20. The hand manipulated wrench of claim 1, wherein:
the handle assembly includes a cam element which engages the handle and the rotating element, wherein the force applied to the handle is transmitted through the cam element and the rotating element to the second jaw to apply the closing force to the second jaw.

21. The hand manipulated wrench of claim 20, wherein:
the cam element is rotatably coupled to the body.

22. The hand manipulated wrench of claim 1, wherein:
the force transmitting assembly exerts the closing force when the force applied to the handle is in the direction applied to torque the item engaged by the first and second jaws.

23. An improvement in a hand manipulated wrench, the hand manipulated wrench having a first jaw, a second jaw, a body, a rotating actuator, and a handle, the second jaw being movable relative to the first jaw and both the first and second jaws being mounted to the body, the rotating actuator being manually manipulated to continuously change the distance between the first and second jaws, the second jaw being slidably mounted to the body for movement toward and away from the first jaw, the improvement comprising:
a force transmitting assembly coupled to the handle, the force transmitting assembly being coupled to the second jaw to apply a closing force to the second jaw when a force is exerted on the handle by the user.

24-41. (canceled)

42. A hand manipulated wrench, comprising:
a body;
a first jaw having a plurality of teeth and being mounted to the body;
a second jaw mounted to the body;
a handle assembly having a handle, the handle being pivotally mounted to the body, the handle assembly also having a plurality of teeth which matingly engage the plurality of teeth on the first jaw;
a force transmitting mechanism which applies a closing force to the first jaw when a force is applied to the handle to torque an item held between the first and second jaws.

43. The hand manipulated wrench of claim 42, wherein:
a spring positioned to move the first jaw away from the second jaw.

44. The hand manipulated wrench of claim 42, wherein:
the force transmitting assembly includes a cam, the cam having a portion engaged by the handle and another portion which engages the second jaw so that forces exerted by the handle on the cam are transferred to the first jaw by the cam.

45. The hand manipulated wrench of claim 42, wherein:
the cam includes a release, the release permitting the first jaw to slide relative to the second jaw.

46. The hand manipulated wrench of claim 12, wherein:
the pin engages the adjustor to force the second jaw toward the first jaw.
